(19) United States
(12) Patent Application Publication
(10) Pub. No.: US 2024/0221260 A1
(43) Pub. Date: Jul. 4, 2024

(54) END-TO-END VIRTUAL HUMAN SPEECH AND MOVEMENT SYNTHESIZATION

(71) Applicant: SAMSUNG ELECTRONICS CO., LTD., Gyeonggi-Do (KR)

(72) Inventors: Dimitar Petkov Dinev, Sunnyvale, CA (US); Ondrej Texler, San Jose, CA (US); Siddarth Ravichandran, Santa Clara, CA (US); Janvi Chetan Palan, Santa Clara, CA (US); Hyun Jae Kang, Mountain View, CA (US); Ankur Gupta, San Jose, CA (US); Anil Unnikrishnan, Dublin, CA (US); Anthony Sylvain Jean-Yves Liot, San Jose, CA (US); Sajid Sadi, San Jose, CA (US)

(21) Appl. No.: 18/342,721

(22) Filed: Jun. 27, 2023

Related U.S. Application Data
(60) Provisional application No. 63/436,058, filed on Dec. 29, 2022.

(51) Int. Cl. G06T 13/40; G06T 13/20; G06T 19/20; G06V 40/16; G06V 40/20

(52) U.S. Cl. CPC G06T 13/40; G06T 13/205; G06T 19/20; G06V 40/174; G06V 40/20; G06T 2219/2004

(57) ABSTRACT

Synthesizing speech and movement of a virtual human includes capturing supplemental data generated by a transducer. The supplemental data specifies one or more attributes of a user. The capturing is performed in substantially real-time with the user providing input to a conversational platform. A behavior determiner generates behavioral data based on the supplemental data and an audio response generated by the conversational platform in response to the input to the conversation platform. Based on the behavioral data and the audio response, a rendering network generates a video rendering of a virtual human engaging in a conversation with the user, the video rendering synchronized with the audio response.

### CROSS-REFERENCE TO RELATED APPLICATIONS

This application claims the benefit of U.S. Application No. 63/436,058 filed on Dec. 29, 2022, which is incorporated herein by reference in its entirety.

### TECHNICAL FIELD

This disclosure relates to creating visual representations of virtual humans that include accurate head and body motion synchronized with simulated speech.

### BACKGROUND

Virtual humans are becoming increasingly popular owing to various reasons such as the increasing popularity of the Metaverse, the adoption of virtual experiences across different segments of society, and recent advances in hardware and other technologies such as neural networks that facilitate rapid virtualization. A virtual human is a computer-generated entity that is rendered visually with a human-like appearance. Virtual humans may also be referred to as “digital humans.” A virtual human is often combined with elements of artificial intelligence (AI) that allow the virtual human to interpret user input and respond to the user input in a contextually appropriate manner. For example, one objective of virtual human technology is to endow the virtual human with the ability to interact with human beings using contextually appropriate verbal and non-verbal cues. By incorporating Natural Language Processing (NLP) capabilities with the virtual human, the virtual human may provide human-like interactions with users and/or perform various tasks such as, for example, scheduling activities, initiating certain operations, terminating certain operations, and/or monitoring certain operations of various systems and devices. Virtual humans may also be used as avatars.

Creating a virtual human is a complex task. A virtual human is often created using one or more neural networks and corresponding deep learning. Giving the virtual human lifelike qualities requires complex systems with many different components and various types of data. An accurate rendering of the face of a virtual human is typically of paramount importance, as humans are particularly perceptive of minute inaccuracies in the mouth and lip movements of the virtual human as it is speaking.

### SUMMARY

In one or more embodiments, a computer-implemented method includes capturing supplemental data generated by a transducer. The supplemental data specifies one or more attributes of a user. Capturing supplemental data is performed in substantially real-time with the user providing input to a conversational platform. The method includes generating, by a behavior determiner, behavioral data based on the supplemental data and an audio response generated by the conversational platform in response to the input to the conversation platform. The method includes generating, by a rendering network, based on the behavioral data and the audio response, a video rendering synchronized with the audio response of a virtual human engaging in a conversation with the user.

In one aspect, generating the video rendering includes combining the audio response with the behavioral data to generate one or more head poses of the virtual human during the conversation. Mouth and lip movements of the virtual human are synchronized with a rendering of the audio response during the conversation.

In another aspect, the supplemental data includes user speech. Generating behavioral data includes generating behavioral data, at least in part, based on a machine-generated sentiment analysis of the user speech.

In another aspect, supplemental data includes one or more user facial expressions. Generating behavioral data includes generating behavioral data, at least in part, based on a machine-generated expression analysis of one or more user facial expressions.

In another aspect, generating the video rendering includes combining the audio response and the behavioral data to generate both head and body movements of the virtual human during the conversation. The rendering network comprises distinct subnetworks for generating, respectively, the head and body movements of the virtual human during the conversation.

In one or more embodiments, a system includes one or more processors configured to initiate operations. The operations include capturing supplemental data generated by a transducer. The supplemental data specifies one or more attributes of a user. Capturing supplemental data is performed in substantially real-time with the user providing input to a conversational platform. The operations include generating, by a behavior determiner, behavioral data based on the supplemental data and an audio response generated by the conversational platform in response to the input to the conversation platform. The operations include generating, by a rendering network, based on the behavioral data and the audio response, a video rendering synchronized with the audio response of a virtual human engaging in a conversation with the user.

In one aspect, generating the video rendering includes combining the audio response with the behavioral data to generate one or more head poses of the virtual human during the conversation. Mouth and lip movements of the virtual human are synchronized with a rendering of the audio response during the conversation.

In another aspect, the supplemental data includes user speech. Generating behavioral data includes generating behavioral data, at least in part, based on a machine-generated sentiment analysis of the user speech.

In another aspect, supplemental data includes one or more user facial expressions. Generating behavioral data includes generating behavioral data, at least in part, based on a machine-generated expression analysis of one or more user facial expressions.

In another aspect, generating the video rendering includes combining the audio response and the behavioral data to generate both head and body movements of the virtual human during the conversation. The rendering network comprises distinct subnetworks for generating, respectively, the head and body movements of the virtual human during the conversation.

In one or more embodiments, a computer program product includes one or more computer readable storage media having program code stored thereon. The program code is executable by one or more processors to perform operations. The operations include capturing supplemental data generated by a transducer. The supplemental data specifies one or more attributes of a user. Capturing supplemental data is performed in substantially real-time with the user providing input to a conversational platform. The operations include generating, by a behavior determiner, behavioral data based on the supplemental data and an audio response generated by the conversational platform in response to the input to the conversation platform. The operations include generating, by a rendering network, based on the behavioral data and the audio response, a video rendering synchronized with the audio response of a virtual human engaging in a conversation with the user.

In one aspect, generating the video rendering includes combining the audio response with the behavioral data to generate one or more head poses of the virtual human during the conversation. Mouth and lip movements of the virtual human are synchronized with a rendering of the audio response during the conversation.

In another aspect, the supplemental data includes user speech. Generating behavioral data includes generating behavioral data, at least in part, based on a machine-generated sentiment analysis of the user speech.

In another aspect, supplemental data includes one or more user facial expressions. Generating behavioral data includes generating behavioral data, at least in part, based on a machine-generated expression analysis of one or more user facial expressions.

In another aspect, generating the video rendering includes combining the audio response and the behavioral data to generate both head and body movements of the virtual human during the conversation. The rendering network comprises distinct subnetworks for generating, respectively, the head and body movements of the virtual human during the conversation.

This Summary section is provided merely to introduce certain concepts and not to identify any key or essential features of the claimed subject matter. Many other features and embodiments of the invention will be apparent from the accompanying drawings and from the following detailed description.

### BRIEF DESCRIPTION OF THE DRAWINGS

The accompanying drawings show one or more embodiments; however, the accompanying drawings should not be taken to limit the invention to only the embodiments shown. Various aspects and advantages will become apparent upon review of the following detailed description and upon reference to the drawings.

FIG. 1 illustrates an example of an architecture that is executable by a data processing system to generate a video rendering of a virtual human engaging in a conversation with a user.

FIG. 2 illustrates an example method that may be performed by a system executing the architecture of FIG. 1.

FIG. 3 illustrates another example architecture executable by a data processing system to generate a video rendering of a virtual human engaging in a conversation with a user.

FIG. 4 illustrates an example implementation of a data processing system capable of executing the architectures described within this disclosure.

### DETAILED DESCRIPTION

While the disclosure concludes with claims defining novel features, it is believed that the various features described herein will be better understood from consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to creating visual representations of virtual humans that include accurate head and body motion synchronized with simulated speech. A rendering includes facial movements (e.g., a talking animation) and expressions, for rendering a virtual human. So-called “deepfakes” have been developed to create videos of artificial humans (e.g., avatars). But these deepfakes typically involve capturing a particular subject, and then either driving the synthetic video with another video (e.g., transferring motion from another video onto the current subject) or with audio. Giving a digital assistant, chatbot, or other application a lifelike visual quality by synthesizing lip movement and speech, as well as matching facial expressions and body movements, during an interactive conversation with a user remains an open challenge. For the digital virtual assistant whose primary purpose is engaging in conversation and interacting with a user, lip-sync fidelity and similar characteristics are vital to creating truly lifelike virtual humans.

In accordance with the inventive arrangements disclosed herein, methods, systems, and computer program products are provided for rendering a virtual human whose lip movements, facial expressions, and body motions mimic those of human engaged in a conversation with another human (the user). Humans engaged in a conversation typically exhibit body movements and facial expressions as well as muscle movements of the mouth and lips when speaking. Nonverbal actions of a human engaged in conversation may include nodding in agreement while listening, scowling slightly in disagreement, raising an eyebrow in surprise, and similar such movements. Giving the virtual human a capability to make similar movements as appropriate to a particular conversation adds to the virtual human's believability. The inventive arrangements accurately capture these movements using a machine learning model (e.g., deep learning neural network) to generate behavioral data. Behavioral data is an input to a rendering network also comprising a machine learning model (e.g., convolutional neural network).

One aspect of the inventive arrangements is an end-to-end pipeline to generate visual renderings of a virtual human. The virtual human realistically engages in real-time conversation with a user. The end-to-end pipeline includes a behavior determiner. The behavior determiner generates behavioral data based on attributes or characteristics of the user. The user attributes, such as user input (speech or text) to a conversational platform, can be captured by a transducer (e.g., video camera with microphone). The user attributes can indicate the sentiment or emotion of the user. The behavior data generated therefrom by the behavior data is fed into a rendering network. The rendering network is trained to render the virtual human with expressions (e.g., smile) and actions (e.g., knowing nod) that accurately reflect the context of a conversation with the user as the conversation is occurring. The rendering based on behavior data enables the virtual human to communicate nonverbally with the user. For example, while the user is asking a question, the virtual human may nod its head knowingly. If the user appears upset, the virtual human's expression can be one of sympathy. These attributes of the virtual human, even when not speaking, make the virtual human much more lifelike and its conversation with the user much closer to a real-life conversation.

The end-to-end pipeline uses video (e.g., annotated segments) of a subject speaking and performing actions that, given the context of the conversation, the virtual human should exhibit (e.g., smile, nod, etc.). The annotations for the appropriate video segments thus train the behavior determiner. Once trained on the annotated segments, the behavior determiner is capable of generating outputs (e.g., contour drawings) that when fed into the rendering network guide the network in generating a video rendering of the virtual human. The behavior determiner may use several different inputs to predict the correct facial expression the virtual human should exhibit and/or the action it should take during any given moment of conversation with the user. Training data for the behavior determiner can come from a variety of sources, including, for example, head motion generated from the audio data, expression analysis of the user's face, or sentiment analysis of the audio or text input by the user to a conversational platform.

The rendering network is trained using two inputs. One is contour drawings (the type the behavior determiner outputs) and audio data. Audio data can take on several forms, including raw waveforms, mel-frequency cepstrum coefficients, and/or viseme coefficients. The rendering network uses the audio data to synthesize the appropriate mouth shape and synchronize lip movements and combines the audio data with the guidance of the behavioral data generated by the behavior determiner. The rendering network is trained to produce a correct head pose for the video rendering of the virtual human. Once trained, the rendering network at inference time generates a video rendering of a digital human whose movements and facial expressions accurately reflect the context of a conversation with a user.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

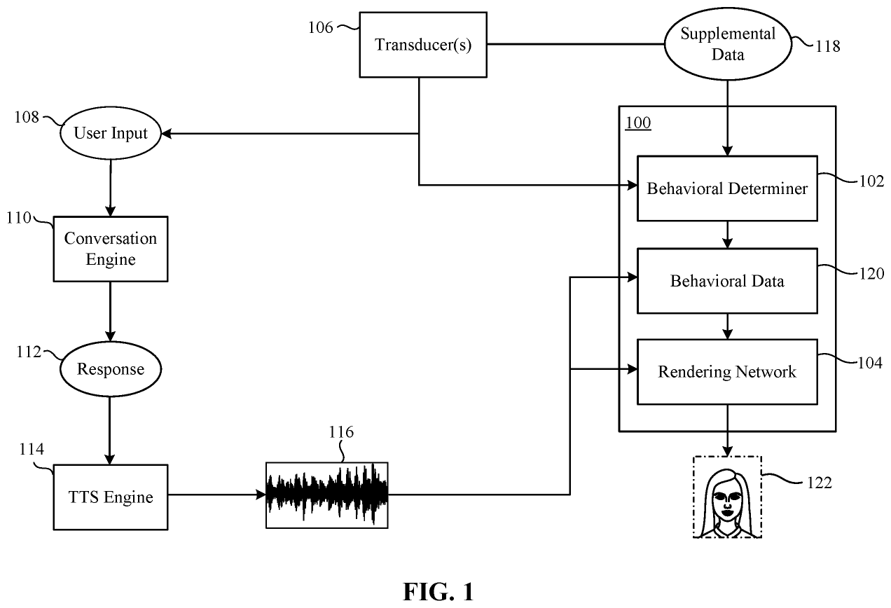

FIG. 1 illustrates an example architecture of a virtual human rendering framework (framework) 100. Framework 100 is capable of generating a visual representation such as an image or video rendering of a virtual human. The virtual human is not a real human, but rather a simulation (e.g., avatar) of a human. The virtual human rendered by framework 100 is capable of engaging in a real-time conversation with a human user by voicing logical responses to the user. While engaged in conversation with the user, the virtual human exhibits mouth and lip movements synchronized with the words simulated to be spoken by the virtual human. The virtual human exhibits facial movements and expressions (e.g., smile, frown, raised eyebrows) consistent with the words spoken by the virtual human and appropriate to the words spoken by the user.

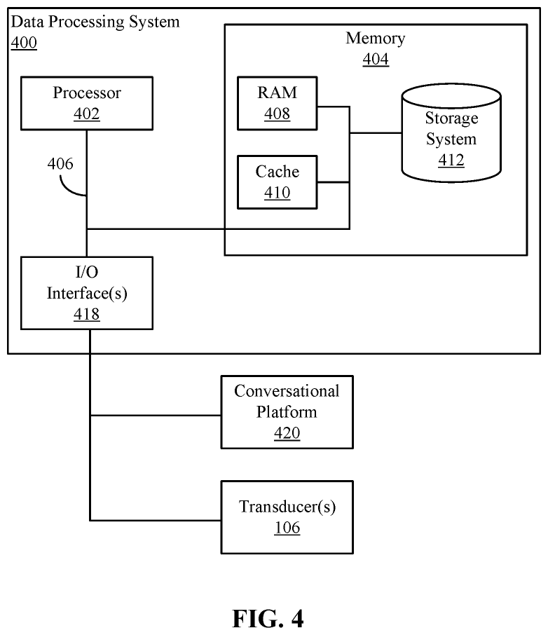

Framework 100 may be implemented as a software framework that is executable by a data processing system. An example of a data processing system that is suitable for executing framework 100 as described herein is the data processing system 400 described below in connection with FIG. 4. Illustratively, framework 100 includes behavior determiner 102 and rendering network 104.

Operatively, framework 100 receives multi-modal data (voice, text, image) from one or more transducers 106. Transducer(s) 106, for example, can be a video camera integrated with a microphone or separate devices that capture audio signals and images. In certain arrangements, for example, transducers 106 can be mounted on a display configured to present a video rendering of a virtual human endowed with capabilities provided by framework 100. In such arrangements, the display can be positioned at a kiosk (e.g., at an airport, hotel lobby, restaurant) such that virtual human acts as a digital assistant for users at the kiosk.

In certain embodiments, transducer(s) 106 capture and convey user input 108 (e.g., voice) to conversation engine 110. User input 108, additionally or alternatively, may include text conveyed by a user via a wireless device communicatively coupled with conversation engine 110 or using a keypad coupled thereto. Conversation engine 110 may be implemented with an off-the-shelf solution (e.g., GPT3). Conversation engine 110 determines an appropriate reply to user input 108 and generates response 112 to user input 108. Response 112, if text based, is fed into text-to-speech (TTS) engine 114. TTS engine 114 likewise can be implemented using an off-the-shelf solution (e.g., Bixby Voice®) to convert response 112 to audio response 116. Audio response 116 is fed to behavior determiner 102 of framework 100.

Transducer(s) 106 also may additionally capture supplemental data 118, which is fed to behavior determiner 102 along with user input 108 and audio response 116. Supplemental data 118 may include video that captures the user's facial expressions and gestures (e.g., pointing, nodding). Behavior determiner 102 implements a machine learning model (e.g., deep learning neural network) trained to predict the emotive condition of the user based on user attributes (e.g., tone of voice, facial expressions, gestures, words spoken and/or written) as determined from user input 108 and supplemental data 118.

Behavior determiner 102 implements a machine learning model (e.g., deep learning neural network) that is trained to output behavioral data 120 based on the user's emotive content. Behavioral data 120 is fed to rendering network 104 and used by rendering network 104 to render a virtual human with physical characteristics (e.g., facial expressions, head movements) appropriate to the conversation in which the virtual human engages with a user and consistent with the user's emotive condition, as predicted by behavior determiner 102.

Behavior determiner 102 is trained to output behavioral data 120 based on various types of supplemental data 118 in addition to user input 108 and audio response 116. Audio response 116 determines, at least partly, the virtual human's behavior since the behavior should reflect the words the virtual human speaks to the user. Behavioral data 120, however, also comprises data that makes the virtual human's behavior appropriate to the emotive condition of the user (e.g., frustrated, angry, questioning). Thus, even if the virtual human is not speaking to the user, behavioral data 120 is used to guide rendering network 104's rendering of the virtual human such that it exhibits expressions (e.g., furrowed brow of concern or sympathy for an upset user) and/or actions (e.g., head nodding knowingly as the user makes a request) appropriate to the user's emotive condition. The virtual human's ability to communicate non-verbally as well as verbally greatly enhances its lifelike qualities.

Supplemental data 118 may include audio and/or text according to whether the user conveyed user input 108 to conversation engine 110 by voice or in writing. Behavior determiner 102 can be trained to perform machine-generated sentiment analysis on the user's spoken or written words. The nature of words themselves can be used by behavior determiner 102 to predict the user's emotive condition, for example, whether the user is passively seeking information, or whether the user is frustrated or angry over something.

If all or a portion of user input 108 is voice based, then the machine-generated sentiment analysis performed by behavior determiner 102 can include machine-generated tone analysis of the user's tone of voice. The tone of voice is another predictor of the user's emotive condition.

In addition to inferring user sentiment from written or spoken words and/or tone of voice, the user's emotive condition is predicted by behavior determiner 102 from visual cues from video or images captured as part of supplemental data 118. Visual cues include, for example, the user's facial expression (e.g., smile, frown), body movement (e.g., shaking the head to indicate agreement or negation), and other physical attributes (e.g., hand gestures). Thus, supplemental data 118 also may include image signals captured by transducer(s) 106, the images showing for example the attributes mentioned such as head movements, facial expressions, hand gestures, and the like. Behavior determiner 102 can be trained to perform a machine-generated expression analysis on the user's facial expression as well as other user attributes (e.g., head movement, hand gestures), all of which may be used by behavior determiner 102 to predict the user's emotive condition.

As a deep learning neural network, behavior determiner 102 may be trained through machine learning with video (annotated segments) of a subject exhibiting specific physical attributes, such as speaking, smiling, nodding, frowning, etc. Behavior determiner 102 learns to associate the specific user attributes and sentiments described above with an appropriate physical response for the virtual human. The virtual human's physical attributes, for example, may be a smile as the user approaches, a reassuring nod as the user poses a question, or a concerned frown if the user is upset or angry. Based on the user's predicted emotive condition, behavior determiner 102 outputs behavioral data 120. Behavioral data 120 may include contours (i.e., drawings, segmentation maps, mesh renderings or other representation of pose) that are fed into rendering network 104 to generate the video rendering of the virtual human having expressions and taking actions appropriate to the current context of the conversation. Contours, for example, may specify spatial arrangement of the virtual human's eyes and eyebrows, as well as whether the eyes are open, eyebrows raised, and position of the head. Thus, the contours guide rendering network 104 in rendering the virtual human, such that the appearance of the virtual human has the lifelike quality of appearing to understand the context of each interaction with the user at each point during a conversation.

Rendering network 104 implements a machine learning model (e.g., convolutional neural network). Machine learning of rendering network 104 relies on two distinct types of data. One is behavior data 120 (e.g., contours) generated by behavior determiner 102, as described above. The other type is audio data such as the type generated by a conversation platform. The audio data may take on various distinct forms, including audio waveforms and mel-frequency cepstrum coefficients (MFCC). The audio data also may include viseme features. A viseme specifies a shape of the mouth at the apex of a given phoneme. Each phoneme is associated with, or generated by, one viseme. Each viseme may represent one or more phonemes, and thus, there is a many to one mapping of phonemes to visemes. Visemes are typically generated as artistic renderings of the shape of a mouth (e.g., lips, in speaking a particular phoneme) and convey 3D data of the shape of a mouth in generating phoneme(s) mapped thereto.

During a training phase, rendering network 104 combines audio data to synthesize the appropriate mouth shape and combines it with the guidance of behavioral data 120 to produce the correct head pose. At inference time, the now-trained rendering network 104 generates video rendering 122 of the virtual human engaging in a conversation with the user. Video rendering 122 comprises a video or series of images that simulate a human. It is not an actual human being but rather a computer simulation (e.g., avatar). The virtual human's speech is generated at inference time by rendering network 104 combining audio response 116 generated by conversation engine 110 with behavior data 120 generated by behavior determiner 102. Expressions, including head pose, of the virtual human in video rendering 122, at any given moment of a conversation, accurately match the context of the virtual human's interaction with the user. The speech and behavior (e.g., expression, head pose, etc.) of the virtual human as embodied in video rendering 122 are generated in response to the received user input 108. As generated, video rendering 122 is synchronized with audio response 116.

Rendering network 104 is capable of generating video rendering 122 in real time or in substantially real time. For example, video rendering 122 may be rendered at a minimum of thirty frames per second. Rendering network 104 generates video rendering 122 based on behavioral data 120 generated by behavior determiner 102. Accordingly, behavior determiner 102 may output behavioral data 120 at a rate commensurate with the minimum thirty frames per second, subject to the optional use of known optimization techniques as appropriate. Supplemental data 118, on which behavior determiner 102 relies for generating behavioral data 120, may be received by behavior determiner 102 continually and, as such, may influence the images of the virtual human that form the video (movement) that is generated on a frame-by-frame basis by rendering network 104. That is, each frame generated is directly influenced by, and a response to, the behavioral data 120 generated in response to supplemental data 118 corresponding to the user and captured by transducer(s) 106 in real time or substantially in real time.

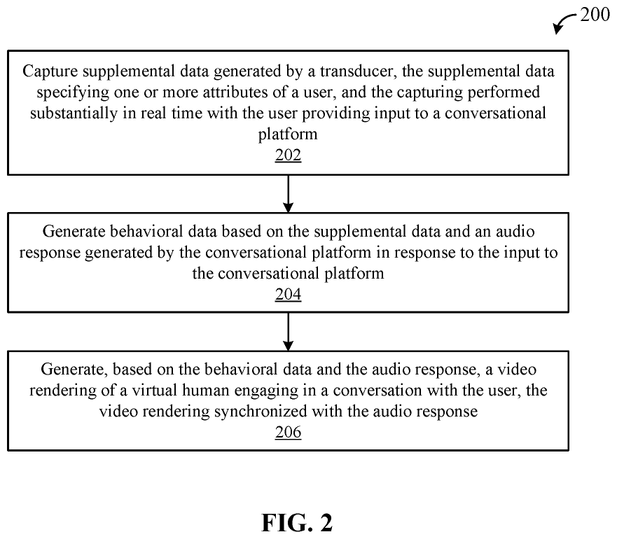

FIG. 2 illustrates an example method 200 that may be performed by a system executing framework 100. As noted above, framework 100 may be executed by a data processing system (e.g., computer) such as data processing system 400 described in connection with FIG. 4 or another suitable computing system.

In block 202, the system obtains supplemental data 118 captured by one or more transducers 106 (e.g., video camera with microphone). Supplemental data 118 specifies one or more attributes of a user. Supplemental data 118 may include attributes such as user-spoken speech or user-written text input by the user to a conversational platform (e.g., conversation engine 110 and TTS engine 114). Additionally, or alternatively, supplemental data 118 may include user characteristics, such as facial expressions (e.g., smile, frown), or user actions, such as head nodding or hand gestures. The supplemental data 118 obtained by the system is captured by one or more transducers substantially real-time with the user providing user input 108 to the conversational platform. For example, if the system is operatively coupled with a kiosk display for generating a virtual human assistant, the system may capture the user's facial expression as the user approaches the kiosk. The system, for example, may capture the user's hand gestures (e.g., pointing) and facial expression as the user speaks into the conversational platform.

At block 204, the system, implementing behavior determiner 102, generates behavioral data 120 based on supplemental data 118. An advantage of capturing supplemental data 118 in substantially real-time with the user's providing input to the conversational platform is that, even when the virtual human is not speaking (e.g., before a first utterance), supplemental data 118 can be converted to behavior data 120 used to control rendering network 104's rendering of the virtual human. The visual of the virtual human can be rendered to have an appearance appropriate to the context of a conversation with the user. For example, the head pose of the virtual human may nod knowingly if the user is asking a question clearly, or the virtual human may exhibit a perplexed expression if the user's question is unintelligible. Such renderings of the virtual human are possible owing to the generation of behavioral data 120 that is fed into rendering network 104. Behavior determiner 102 also may generate behavioral data 120 based on audio waveform 116, which vocalizes response 112 generated by conversation engine 110 in response to the user input 108.

In block 206, the system, implementing rendering network 104, generates video rendering 122 of the virtual human as the virtual human engages in a conversation with the user. Video rendering 122 is not an actual human being but rather a computer simulation (e.g., avatar) and comprises a video or series of images that simulate a human. Rendering network 104 generates video rendering 122 based on both audio response 116 and supplemental data 118.

In one or more other example implementations, a virtual human generated in accordance with the inventive arrangements described herein may be included in various artificial intelligence chat bots and/or virtual assistant applications as a visual supplement. Adding a visual component in the form of a virtual human to an automated chat bot may provide a degree of humanness, essentially lifelike human features, to user-computer interactions. In such cases, having context-appropriate facial attributes and expressions coupled with accurately synched lip movements, generated as described herein, is important for imbuing the virtual human with lifelike qualities and realism. The disclosed technology thus may be used as a visual component and displayed in a display device and may be paired or used with a smart-speaker virtual assistant to make various types of interactions more human-like.

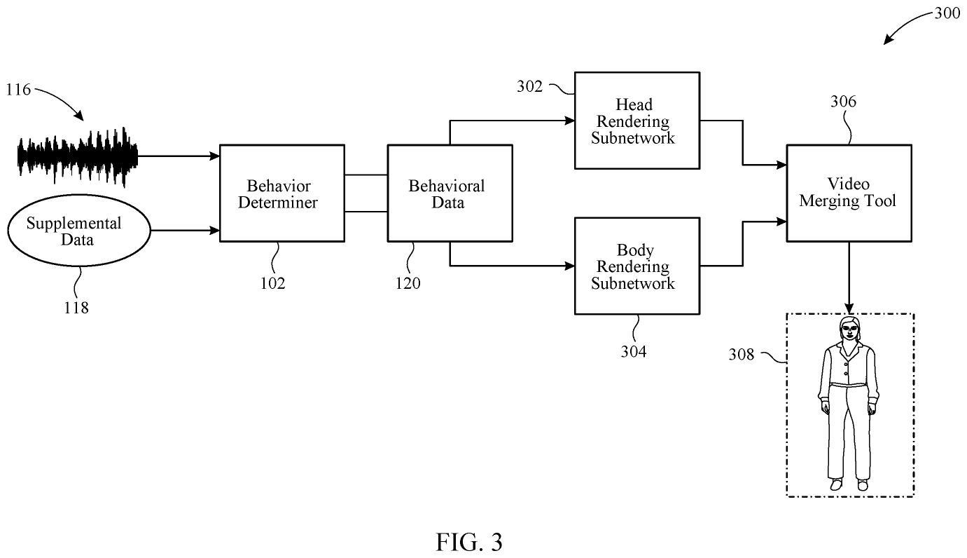

Video rendering 122 has been described thus far essentially in terms of a virtual human's voice, head pose, facial expression, and the like. An even greater human likeness may be achieved if video rendering 122 of the virtual human (e.g., avatar) simulates an entire body representation of a human. Simulating the entire body is more complex. Behavior determiner 102 needs to not only generate behavior data for mouth movements and facial expressions, but also for body movements, therefore, necessitating additional behavior data (control parameters) such as joint angles in a rigged skeleton blender. To make the task more tractable, in certain embodiments as illustrated in FIG. 3, separate rendering subnetworks are implemented.

FIG. 3 illustrates an example whole-body virtual human simulation framework 300. Conversational platform-generated audio response 116 and transducer-captured supplemental data 118 (acquired in the same manner as described above), which are fed to behavior determiner 102. Behavior determiner 102 generates behavioral data 120 for separately controlling head pose and body movement of a virtual human. The respective head-related and body-related behavioral data are fed to two distinct subnetworks (e.g., convolutional neural networks). Head rendering subnetwork 302 generates a video rendering of the virtual human's head pose, including facial expressions, lip movements, etc. Body rendering subnetwork 304 generates a video rendering of the virtual human's body movements synchronized with the speech and head movements of the virtual human. Video merging tool 306 merges the respective video renderings of the virtual human's head pose and body movements to generate video rendering 308, a rendering of the virtual human's entire body. Head rendering subnetwork 302 and body rendering subnetwork 304 both may generate video in real time or in substantially real time (e.g., minimum thirty frames per second). Behavioral data 120 may be generated in response to continually received supplemental data 118 corresponding to the user and captured by transducer(s) 106 in real time or substantially in real time. As discussed, the video output from head rendering subnetwork 302 and body rendering subnetwork 304 is generated responsive to the behavioral data 120 and audio response 116 being generated from interactions with the user.

FIG. 4 illustrates an example implementation of a data processing system 400. As defined herein, the term “data processing system” means one or more hardware systems configured to process data, each hardware system including at least one processor and memory, wherein the processor is programmed with computer-readable instructions that, upon execution, initiate operations. Data processing system 400 can include a processor 402, a memory 404, and a bus 406 that couples various system components including memory 404 to processor 402.

Processor 402 may be implemented as one or more processors. In an example, processor 402 is implemented as a central processing unit (CPU). Processor 402 may be implemented as one or more circuits capable of carrying out instructions contained in program code. The circuit may be an integrated circuit or embedded in an integrated circuit. Processor 402 may be implemented using a complex instruction set computer architecture (CISC), a reduced instruction set computer architecture (RISC), a vector processing architecture, or other known architectures. Example processors include, but are not limited to, processors having a 10×6 type of architecture (IA-32, IA-64, etc.), Power Architecture, ARM processors, and the like.

Bus 406 represents one or more of any of a variety of communication bus structures. By way of example, and not limitation, bus 406 may be implemented as a Peripheral Component Interconnect Express (PCIe) bus. Data processing system 400 typically includes a variety of computer system readable media. Such media may include computer-readable volatile and non-volatile media and computer-readable removable and non-removable media.

Memory 404 can include computer-readable media in the form of volatile memory, such as random-access memory (RAM) 408 and/or cache memory 410. Data processing system 400 also can include other removable/non-removable, volatile/non-volatile computer storage media. By way of example, storage system 412 can be provided for reading from and writing to a non-removable, non-volatile magnetic and/or solid-state media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 406 by one or more data media interfaces. Memory 404 is an example of at least one computer program product.

Memory 404 is capable of storing computer-readable program instructions that are executable by processor 402. For example, the computer-readable program instructions can include an operating system, one or more application programs, other program code, and program data. The computer-readable program instructions may implement any of the different examples of framework 100 and/or 300 as described herein. Processor 402, in executing the computer-readable program instructions, is capable of performing the various operations described herein that are attributable to a computer. It should be appreciated that data items used, generated, and/or operated upon by data processing system 400 are functional data structures that impart functionality when employed by data processing system 400. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor. Examples of data structures include images and meshes.

Data processing system 400 may include one or more Input/Output (I/O) interfaces 418 communicatively linked to bus 406. I/O interface(s) 418 allow data processing system 400 to communicate with one or more external devices and/or communicate over one or more networks such as a local area network (LAN), a wide area network (WAN), and/or a public network (e.g., the Internet). Examples of I/O interface(s) 418 may include, but are not limited to, network cards, modems, network adapters, hardware controllers, etc. Examples of external devices also may include devices that allow a user to interact with data processing system 400 (e.g., a display, a keyboard, a microphone for receiving or capturing audio data, speakers, and/or a pointing device).

I/O interface(s) 418 may communicatively couple processor 402 and memory 404 via bus 406 with conversation platform 420 (including conversation engine 110 and TTS engine 114). Processor 402 and memory 404 may also couple through I/O interface(s) 418 with transducer(s) 106, described above.

Data processing system 400 is only one example implementation. Data processing system 400 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

The example of FIG. 4 is not intended to suggest any limitation as to the scope of use or functionality of example implementations described herein. Data processing system 400 is an example of computer hardware that is capable of performing the various operations described within this disclosure. In this regard, data processing system 400 may include fewer components than shown or additional components not illustrated in FIG. 4 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B, and C.” “at least one of A, B, or C.” “one or more of A, B, and C.” “one or more of A, B, or C.” and “A, B, and/or C” means A alone, B alone, C alone, A and B together, A and C together, B and C together, or A, B and C together.

As defined herein, the term “automatically” means without user intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of a computer readable storage media. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments.” and similar language throughout this disclosure may, but do not necessarily, all refer to the same embodiment. The terms “embodiment” and “arrangement” are used interchangeably within this disclosure.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real-time” means a level of processing responsiveness that a user or system senses as sufficiently immediate for a particular process or determination to be made, or that enables the processor to keep up with some external process.

As defined herein, the term “responsive to” and similar language as described above, e.g., “if.” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or media) having computer readable program instructions thereon for causing a processor to carry out aspects of the present invention. Within this disclosure, the term “program code” is used interchangeably with the term “computer readable program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A computer-implemented method, comprising:
capturing supplemental data generated by a transducer, wherein the supplemental data specifies one or more attributes of a user, and wherein the capturing is performed in substantially real-time with the user providing input to a conversational platform;
generating, by a behavior determiner, behavioral data based on the supplemental data and an audio response generated by the conversational platform in response to the input to the conversational platform; and
generating, by a rendering network, based on the behavioral data and the audio response, a video rendering of a virtual human engaging in a conversation with the user, wherein the video rendering is synchronized with the audio response.

2. The computer-implemented method of claim 1, wherein the generating the video rendering comprises:
combining the audio response and the behavioral data to generate one or more head poses of the virtual human during the conversation; and
synchronizing mouth and lip movements of the virtual human with the audio response during the conversation.

3. The computer-implemented method of claim 1, wherein the supplemental data includes user speech, and wherein the generating the behavioral data includes:
generating behavioral data, at least in part, based on a machine-generated sentiment analysis of the user speech.

4. The computer-implemented method of claim 1, wherein the supplemental data includes one or more user facial expressions, and wherein the generating the behavioral data includes:
generating behavioral data, at least in part, based on a machine-generated expression analysis of the one or more user facial expressions.

5. The computer-implemented method of claim 1, wherein the rendering network is trained using machine learning with training data that includes annotated audio and video segments.

6. The computer-implemented method of claim 1, wherein the generating the video rendering comprises:
combining the audio response and the behavioral data to generate both head and body movements of the virtual human during the conversation.

7. The computer-implemented method of claim 6, wherein the rendering network comprises distinct subnetworks for generating, respectively, the head and body movements of the virtual human during the conversation.

8. A system, comprising:
one or more processors configured to initiate operations including:
capturing supplemental data generated by a transducer, wherein the supplemental data specifies one or more attributes of a user, and wherein the capturing is performed in substantially real-time with the user providing input to a conversational platform;
generating, by a behavior determiner, behavioral data based on the supplemental data and an audio response generated by the conversational platform in response to the input to the conversation platform; and
generating, by a rendering network, based on the behavioral data and the audio response, a video rendering of a virtual human engaging in a conversation with the user, wherein the video rendering is synchronized with the audio response.

9. The system of claim 8, wherein the generating the video rendering includes:
combining the audio response and the behavioral data to generate one or more head poses of the virtual human during the conversation; and
synchronizing mouth and lip movements of the virtual human with a rendering of the audio response during the conversation.

10. The system of claim 8, wherein the supplemental data includes user speech, and wherein the generating the behavioral data includes:
generating behavioral data, at least in part, based on a machine-generated sentiment analysis of the user speech.

11. The system of claim 8, wherein the supplemental data includes one or more user facial expressions, and wherein the generating the behavioral data includes:
generating behavioral data, at least in part, based on a machine-generated expression analysis of the one or more user facial expressions.

12. The system of claim 8, wherein the rendering network is trained using machine learning with training data that includes annotated audio and video segments.

13. The system of claim 8, wherein the generating the video rendering includes:
combining the audio response and the behavioral data to generate both head and body movements of the virtual human during the conversation.

14. A computer program product, the computer program product comprising:
one or more computer-readable storage media and program instructions collectively stored on the one or more computer-readable storage media, the program instructions executable by a processor to cause the processor to initiate operations including:
capturing supplemental data generated by a transducer, wherein the supplemental data specifies one or more attributes of a user, and wherein the capturing is performed in substantially real-time with the user providing input to a conversational platform;
generating, by a behavior determiner, behavioral data based on the supplemental data and an audio response generated by the conversational platform in response to the input to the conversation platform; and
generating, by a rendering network, based on the behavioral data and the audio response, a video rendering of a virtual human engaging in a conversation with the user, wherein the video rendering is synchronized with the audio response.

15. The computer program product of claim 14, wherein the generating the video rendering includes:
combining the audio response and the behavioral data to generate one or more head poses of the virtual human during the conversation; and
synchronizing mouth and lip movements of the virtual human with a rendering of the audio response during the conversation.

16. The computer program product of claim 14, wherein the supplemental data includes user speech, and wherein the generating the behavioral data includes:
generating behavioral data, at least in part, based on a machine-generated sentiment analysis of the user speech.

17. The computer program product of claim 14, wherein the supplemental data includes one or more user facial expressions, and wherein the generating the behavioral data includes:
generating behavioral data, at least in part, based on a machine-generated expression analysis of the one or more user facial expressions.

18. The computer program product of claim 14, wherein the rendering network is trained using machine learning with training data that includes annotated audio and video segments.

19. The computer program product of claim 14, wherein the generating the video rendering includes:
combining the audio response and the behavioral data to generate both head and body movements of the virtual human during the conversation.

20. The computer program product of claim 19, wherein the rendering network includes distinct subnetworks for generating, respectively, the head and body movements of the virtual human during the conversation.
